(19) United States
(12) Patent Application Publication
(10) Pub. No.: US 2018/0288281 A1
(43) Pub. Date: Oct. 4, 2018

(54) INTERPOLATING PIXEL VALUES

(71) Applicants: Hewlett-Packard Development Company, L.P., Houston, TX (US); Rochester Institute of Technology, Rochester, NY (US)

(72) Inventors: Aneesh Rangnekar, Rochester, NY (US); Peter Bauer, Boise, ID (US); Brent M Bradburn, Boise, ID (US); Mark Shaw, Meridian, ID (US); Eli Saber, Rochester, NY (US); Sanketh Moudgalya, Rochester, NY (US)

(21) Appl. No.: 15/761,959

(22) PCT Filed: Jan. 25, 2016
(86) PCT No.: PCT/US2016/014754

§ 371 Date: Mar. 21, 2018

(51) Int. Cl. H04N 1/48; G06T 3/40; H04N 9/04; H04N 1/028

(52) U.S. Cl. CPC H04N 1/486; H04N 1/028; H04N 9/045; G06T 3/4007

(57) ABSTRACT

In one implementation, a system for interpolating pixel values includes a receiver engine to receive a plurality of scan lines each captured using only two of three different colors of lights from a scanner, wherein each scan line comprises received pixel values for the two different colors of lights used to illuminate the plurality of scan lines, an interpolate engine to interpolate, using the received pixel values for the two different colors, pixel values for the third one of the three different colors by for each scan line to result in a color map, and a display engine to cause to display information relating to an image including the received pixel values and the interpolated pixel values for the three different colors for the plurality of scan lines.

### BACKGROUND

Digital scanning may be useful for generating a digital version of a physical object. For example, digital scanning may be used to generate a digital version of a physical object. Additional examples may include using digital scanning in converting other types of objects to digital form, such as documents.

### BRIEF DESCRIPTION OF THE DRAWINGS

FIG. 1 illustrates a diagram of an example of a system for interpolating pixel values consistent with the present disclosure.

FIG. 2 illustrates a diagram of an example computing device consistent with the present disclosure.

FIG. 3 illustrates a diagram of an example of interpolating pixel values consistent with the present disclosure.

FIG. 4 illustrates a diagram of an example of weighting interpolated pixel values consistent with the present disclosure.

FIG. 5 illustrates a flow diagram depicting an example method for interpolating pixel values consistent with the present disclosure.

### DETAILED DESCRIPTION

Methods, systems, and computer readable medium for interpolating pixel values are described herein. Digital scanning may be a time and resource consuming process. For example, a scanner may record a minimum amount of information about the physical object being scanned to generate a digital image of the physical object that is accurate relative to the original scanned physical object. A scanner may use a tri-stimulus light source to strobe red, green, and blue (RGB) colors respectively in three exposures during a single pass, and reconstruct color data by shifting the red and blue scan line exposures relative to the green scan line exposure. Using three exposures per scan line and reconstructing color data by shifting red and blue scan line exposures to achieve a minimum amount of information for an accurate scan may be time consuming.

As used herein, a scanner refers to a device that optically scans images, printed text, handwriting, and/or an object, and converts the scanned information into a digital image. For example, the scanner may include a charge-coupled device (CCD) or a contact image sensor (CIS) as an image sensor to scan the physical object. The scanner may include a tri-stimulus light source that utilizes two exposures per scan line to achieve an accurate scan of a physical object, as will be further described herein. As used herein, exposure can refer to exposure of the physical object to be scanned to colored light from the scanner.

As used herein, a scan line refers to a single row of pixels. For example, a scan line may include a row of pixels in an image. An image may refer to a raster graphics image comprised of a dot matrix data structure that represents a rectangular grid of pixels.

As used herein, a pixel refers to a point in a raster image that is the smallest controllable element of the raster image. Each pixel in the raster image may be a sample of an original image. For example, each pixel of an image may represent a sample of a physical object scanned by a scanner. A pixel may include a color represented by a combination of red, green, and blue colors.

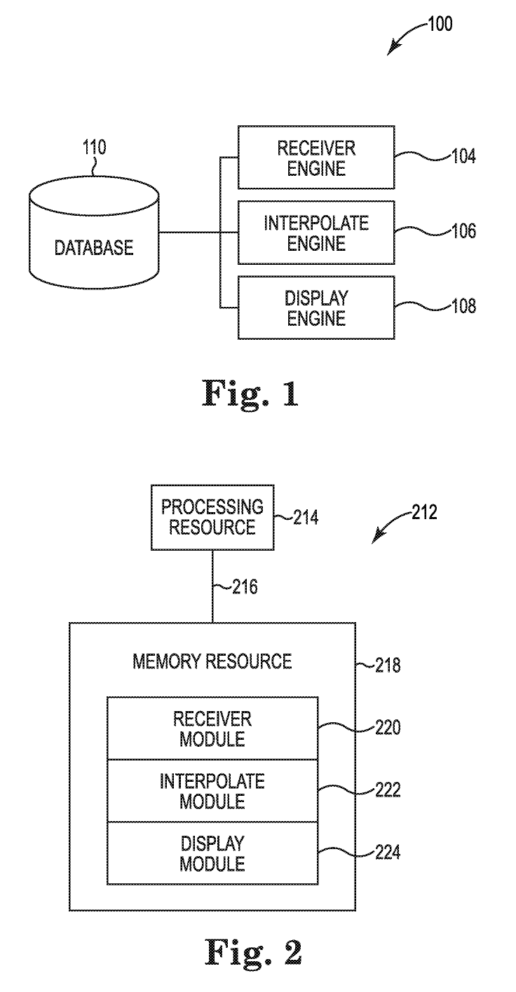

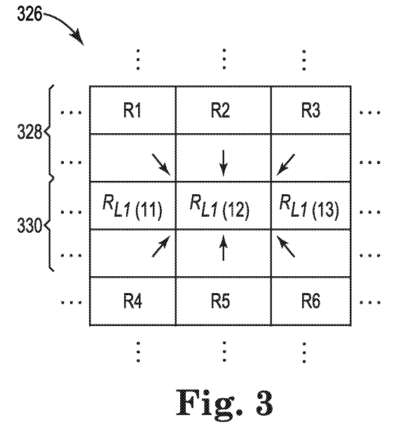

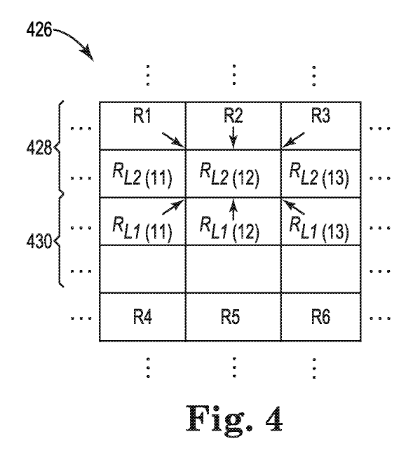

FIG. 1 illustrates a diagram of an example of a system 100 for interpolating pixel values consistent with the present disclosure. The system 100 may include a database 110 and/or a plurality of engines. For instance, the system 100 may include a receiver engine 104, an interpolate engine 106, and a display engine 108. The plurality of engines may be in communication with the database 110 via a communication link. Put another way, the pixel interpolation system 100 may include the receiver engine 104, the interpolate engine 106, and the display engine 108. The system 100 may include additional or fewer engines that are illustrated to perform the various elements as are described in further detail in connection with FIGS. 3 and 4.

The plurality of engines may include a combination of hardware and machine readable instructions that are executable using hardware components such as a processor, but at least hardware, to perform actions described herein. The machine readable instructions may be stored in a memory resource such as a non-transitory machine readable medium. Also, the plurality of engines may be stored as hard-wired program, or logic. As used herein, “logic” is an additional processing resource to perform a particular action and/or operation, etc., described herein, which includes hardware, such as various forms of transistor logic, application specific integrated circuits (ASICs), among others, as opposed to computer executable instructions, stored in memory and executable by a processor.

The receiver engine 104 may include hardware and/or a combination of hardware and machine readable instructions, but at least hardware, to receive a plurality of scan lines from a scanner. Each scan line may include a plurality of pixels. Each pixel may include color information (e.g., red and green, or blue and green color information). Color information of a pixel may include an intensity of each particular color of the pixel. Put another way, the receiver engine 104 may receive a plurality of scan lines each captured using only two of three different colors of lights from a scanner, where each scan line comprises received pixel values for the two different colors of lights used to illuminate the plurality of scan lines. For instance, the two colors used to illuminate the plurality of scan lines may be red and green, as opposed to red, green, and blue. In another example, the two colors used to illuminate the plurality of scan lines may be red and blue, as opposed to red, green, and blue.

The interpolate engine 106 may include hardware and/or a combination of hardware and machine readable instructions, but at least hardware, to interpolate pixel values for the third one of the three different colors for each scan line. For example, the model engine 106 may utilize the color information to interpolate a third color such as blue or red, as is further described herein. Put another way, the interpolate engine 106 may interpolate, using the received pixel values for the two different colors, pixel values for the third one of the three different colors for each scan line to result in a color map. The interpolate engine 106 may interpolate pixel values for the third one of the three different colors by bilinear interpolation, although embodiments of the disclosure are not so limited. As used herein, bilinear interpolation refers to liner interpolation of functions of two variables, for example, on a two-dimensional grid. The two variables may refer to the reference color of a scan line, such as a green color, and one of the two alternate colors of a scan line, such as a red or a blue color. As used herein, a color map may include an array of red, green, and blue (RGB) values. Each red, green, and blue value in the array may include an intensity of each particular RGB color. For example, if the two colors used to illuminate the plurality of scan lines are red and green, then the red and green colors for the pixel values of each scan line may be used to interpolate pixel values for a blue color of each scan line. As another example, if the two colors used to illuminate the plurality of scan lines are blue and green, then green and blue colors for pixel values of each scan line may be used to interpolate pixel values for a red color for each scan line. Hence, pixel values for the blue color of a scan line and pixel values for the red color of another scan line may be interpolated by bilinear interpolation.

In some examples, the interpolate engine 106 may determine the pixel values for the third color by interpolation of the pixel values of the two colors with respect to the pixel values of the third color, as discussed further in relation to FIGS. 3 and 4. Additionally, the interpolated pixel values may be weighted by the color map, as discussed further in relation to FIGS. 3 and 4.

In some examples, an edge map engine may determine pixels adjacent to a pixel on an edge of the image. Pixels adjacent to a pixel on an edge of the image may be used to interpolate a pixel value for the pixel on the edge of the image, as discussed further in relation to FIGS. 3 and 4.

The display engine 108 may include hardware and/or a combination of hardware and machine readable instructions, but at least hardware, to display information relating to an image including the received pixel values and the interpolated pixel values for the three different colors for the plurality of scan lines.

The database 110 may include digital information relating to the scanned physical object, such as a two dimensional (2D) object and/or a three dimensional (3D) object. That is, the database 110 may be utilized to store a digital image of the scanned physical object. For example, the digital image may include image data that may include scan lines including pixels. The database 110 may include the image data of the scanned physical object.

FIG. 2 illustrates a diagram of an example computing device 212 consistent with the present disclosure. The computing device 212 may include hardware, machine readable instructions on a non-transitory machine readable medium, or a combination thereof, to perform the elements described herein.

The computing device 212 may be any combination of hardware and machine readable instructions to share information. The hardware, for example, computing device 212 may include a processing resource 214 and/or a memory resource 218. The memory resource 218 may include computer-readable medium (CRM), machine readable medium (MRM), and/or a database, among other memory resources. A processing resource 214, as used herein, may include any number of processors capable of executing instructions stored by the memory resource 218. Processing resource 214 may be implemented in a single device or distributed across multiple devices. The instructions may be stored on the memory resource 218 and executable by the processing resource 214 to implement a desired action, such as receive a plurality of scan lines each captured using only two of three different colors of lights from a scanner, interpolate, using the received pixel values for the two different colors, pixel values for the third one of the three different colors for each scan line to result in a color map, and display information relating to an image including the received pixel values and the interpolated pixel values for the three different colors for the plurality of scan lines.

The memory resource 218 may be in communication with a processing resource 214. A memory resource 218, as used herein, may include any number of memory components capable of storing instructions that may be executed by processing resource 214. Such memory resource 218 may be a non-transitory CRM or MRM. Memory resource 218 may be integrated in a single device or distributed across multiple devices. Further, memory resource 218 may be fully or partially integrated in the same device as processing resource 214 or it may be separate but accessible to that device and processing resource 214. Thus, it is noted that the computing device 212 may be implemented on a participant device, on a server device, on a collection of server devices, and/or a combination of the participant device and the server device.

The memory resource 218 may be in communication with the processing resource 214 via a communication link (e.g., a path) 216. The communication link 216 may be local or remote to a machine, such as a computing device, associated with the processing resource 214. Examples of a local communication link 216 may include an electronic bus internal to a machine, such as a computing device, where the memory resource 218 is one of volatile, non-volatile, fixed, and/or removable storage medium in communication with the processing resource 214 via the electronic bus.

A plurality of modules, such as receiver module 220, interpolate module 222, and display module 224, may include machine-readable instructions that when executed by the processing resource 214 may perform actions. The plurality of modules may be sub-modules of other modules. For example, the receiver module 220 and the interpolate module 222 may be sub-modules and/or included within the same computing device. In another example, the plurality of modules may comprise individual modules at separate and distinct locations.

Each of the receiver module 220, the interpolate module 222, and the display module 224 may include instructions that when executed by the processing resource 214 may operate as a corresponding engine as described herein. For example, the receiver module 220 may include instructions that when executed by the processing resource 214 may operate as the receiver engine 104. That is, the receiver module 220 may receive, from a scanner, a plurality of scan lines each captured using a green color and a red or a blue color of lights from the scanner.

In another example, the interpolate module 222 may include instructions that when executed by the processing resource 214 may operate as the interpolate engine 106. For instance, the interpolate module 222 may interpolate, using the green color and the red color, pixel values for the blue color of a first scan line, as discussed further in relation to FIGS. 3 and 4. Similarly, the interpolate module 222 may interpolate, using the green color and the blue color, pixel values for the red color of a second scan line, as discussed further in relation to FIGS. 3 and 4.

In another example, the display module 224 may include instructions that when executed by the processing resource 214 may operate as the display engine 108. That is, the display module 224 may cause to display, via a user interface, information related to an image including the plurality of scan lines.

In some examples, the memory resource 218 may further include instructions to filter the plurality of scan lines by a median filter and/or to adjust a quality of the plurality of scan lines by a Gaussian filter, as discussed further in relation to FIG. 4.

FIG. 3 illustrates a diagram of an example of interpolating pixel values consistent with the present disclosure. As shown in FIG. 3, interpolating pixel values may include a plurality of pixels 326, first scan line 328, and second scan line 330.

A plurality of scan lines can be captured by a scanner using only two of three different colors of lights from the scanner. The scanner may include a tri-stimulus light source that utilizes two exposures per scan line. For example, the scanner may use a first exposure for one of the different colors of lights and a second exposure for a second one of the different colors of lights for each scan line to achieve an accurate scan of a physical object. The three different colors used to illuminate a plurality of scan lines comprising the plurality of pixels 326 may include red, green, and blue (RGB).

Utilizing two exposures per scan line may include illuminating a first scan line 328 with a reference color and a first of two alternate colors of the three different colors of lights of the scanner. For example, for first scan line 328, the reference color may be green, and the first of the two alternate colors of the three different colors of lights of the scanner may be red. That is, utilizing two exposures per scan line may include illuminating a first scan line 328 with a green color and a red color of the three different colors of lights of the scanner.

Utilizing two exposures per scan line may include illuminating a second scan line 330 with a reference color and a second of two alternate colors of the three different colors of lights of the scanner. For example, for second scan line 330, the reference color may be green, and the second of the two alternate colors of the three different colors of lights of the scanner may be blue. That is, utilizing two exposures per scan line may include illuminating the second scan line 330 with a green color and a blue color of the three different colors of lights of the scanner.

Hence, the two alternate colors of the three different colors of lights may be used every other scan line. The exposure sequence for the plurality of scan lines comprising the plurality of pixels 326 results in a Red, Green, Blue, Green, Red, Green, Blue, Green, etc. sequence.

As shown in FIG. 3, first scan line 328 may correspond to a red and green exposure, second scan line 330 may correspond to a blue and green exposure, and subsequent scan lines can repeat this sequence. Since each scan line uses two exposures, the scanner may scan a physical object much faster than scanners using three exposures per scan line. That is, an RG, BG sequence per two scan lines may scan the physical object faster than a scanner scanning RGB for each scan line.

In the example shown in FIG. 3, the red, green, and blue colors for the pixel values of each scan line may be used to interpolate pixel values for a red color for each scan line. For example, pixel R_{L1(12)} included in second scan line 330 may include blue and green color information, but lack red color information. Red color information for pixel R_{L1(12)} may therefore be interpolated using color information from adjacent pixels and scan lines.

Interpolating pixel values for the first of the two alternate colors for the second scan line 330 may include interpolation using pixel values of a reference color and pixel values of a second of two alternate colors. For example, interpolating pixel values for the red color for the second scan line 330 may include bilinear interpolation using pixel values of the green color and pixel values of the blue color. Interpolating pixel values for the red color for the second scan line 330 may result in a color map, such as an RGB color map.

As described in connection with FIG. 1 and as used herein, bilinear interpolation refers to liner interpolation of functions of two variables, for example, on a two-dimensional grid. The two variables may refer to the reference color of a scan line, such as a green color, and one of the two alternate colors of a scan line, such as a red or a blue color.

As described in connection with FIG. 1 and as used herein, a color map may include an array of red, green, and blue (RGB) values. Each red, green, and blue value in the array may include an intensity of each particular RGB color.

As shown in FIG. 3, bilinear interpolation may be performed to interpolate pixel values for the red color of pixel R_{L1(12)} of second scan line 330 to result in the color map. Bilinear interpolation of the red color of pixel R_{L1(12)} may result in the following equation:

$${R}_{L 1 ( 12 )} = \frac{1}{8} [ \begin{matrix}1 & 2 & 1 \\ 1 & 2 & 1\end{matrix} ] \times [ \begin{matrix}R 1 & R 2 & R 3 \\ R 4 & R 5 & R 6\end{matrix} ] \qquad ( 1 )$$

where R_{L1(12)} is a pixel to be interpolated, R1, R2, and R3 represent pixels including red color information received by the scanner illuminating first scan line 328 with a green reference color and a red color lights of the scanner, and R4, R5, and R6 represent pixels including red color information received by the scanner illuminating a further scan line with a green reference color and a red color lights of the scanner.

Equation 1 may be performed to interpolate the red color of pixel R_{L1(12)} to result in a color map. As illustrated by Equation 1, more importance is given to the pixel values for the red colors of pixels directly above and directly below (e.g., R2 and R5) the pixel in consideration (e.g., R_{L1(12)}) than the pixels diagonal (e.g., R1, R3, R4, and R6) to R_{L1(12)}.

Bilinear interpolation may be performed to interpolate pixel values for a red color of each pixel of second scan line 330, for example. For example, an equation similar to Equation 1 may be continuously used to interpolate pixel values for a red color for each pixel of second scan line 330. That is, pixel values for a red color for pixels R_{L1(13)}, R_{L1(14)}, etc. may be similarly calculated. Further, pixel values for a red color for pixels R_{L1(11)}, R_{L1(10)}, etc. may be similarly calculated.

Although not shown in FIG. 3, interpolating pixel values for the second of the two alternate colors for the first scan line 328 may include interpolation using pixel values of the reference color and pixel values of the first of the two alternate colors. For example, interpolating pixel values for the blue color for the first scan line 328 may include bilinear interpolation using pixel values of the green color and pixel values of the red color. Interpolating pixel values for the red color of the first scan line 328 may result in a color map, such as an RGB color map.

For example, the two colors used to illuminate the first scan line 328 may be red and green. The red and green colors for the pixel values of the first scan line 328 may be used to interpolate pixel values for a blue color for first scan line 328.

In some examples, pixel values for the blue color of the first scan line and pixel values for the red color of the second scan line may be interpolated using bicubic interpolation. As used herein, bicubic interpolation may include interpolating data points, such as pixel values, on a two-dimensional regular rectangular grid. Bicubic interpolation of pixel values for the blue color of the first scan line and the red color of the second scan line, respectively, may be accomplished using Lagrange polynomials, cubic splines, or cubic convolution.

In some examples, pixel values for the blue color of the first scan line and pixel values for the red color of the second scan line may be interpolated using spline interpolation. As used herein, spline interpolation may include interpolating data points, such as pixel values, using a spline piecewise polynomial. A spline may be a function, such as a numeric function, that is piecewise-defined by polynomial functions.

FIG. 4 illustrates a diagram of an example of weighting interpolated pixel values consistent with the present disclosure. As shown in FIG. 4, interpolating pixel values may include a plurality of pixels 426, first scan line 428, and second scan line 430. The plurality of pixels 426, first scan line 428, and second scan line 430, may be the plurality of pixels 326, first scan line 328, and second scan line 330, previously described in connection with FIG. 3, respectively.

Pixel values for a third color may be determined by weighted interpolation of the pixel values of the two colors with respect to the pixel values of the third color. The interpolation may be weighted by a color map, as previously described in connection with FIG. 3. For example, an RGB color map may indicate that pixels in an area to be interpolated are “near-black”, thereby increasing the weightage of the green color when interpolating the red color. As another example, an RGB color map may indicate that pixels in an area to be interpolated are “near-red”, thereby decreasing the weightage of the green color when interpolating the red color.

In the example shown in FIG. 4, the reference color is green, the first of the two alternate colors is red, and pixel values for the red color of the first scan line 428 may be weighted by an interpolation using a red, green, and blue (RGB) color map. For example, bilinear interpolation may be performed to weight pixel values for the red color of the first scan line 428 by using the following equation:

$${R}_{L 2 ( 12 )} = \frac{5}{8} [ \frac{1}{8} [ \begin{matrix}1 & 2 & 1 \\ 1 & 2 & 1\end{matrix} ] \times [ \begin{matrix}R 1 & R 2 & R 3 \\ {R}_{L 1 ( 11 )} & {R}_{L 1 ( 12 )} & {R}_{L 1 ( 13 )}\end{matrix} ] ] + \frac{3}{8} G \qquad ( 2 )$$

where R_{L2(12)} is an interpolated pixel that is to be weighted, R1, R2, and R3 represent pixels including red color information received by the scanner illuminating first scan line 428 by a red exposure, R_{L1(11)}, R_{L1(12)}, and R_{L1(13)} represent pixels including red color information previously interpolated by bilinear interpolation, as previously described in connection with FIG. 3, and G represents pixels including green color information received by the scanner illuminating first scan line 428 by a green exposure.

Weighted bilinear interpolation may be performed to weight pixel values for a red color of each pixel of first scan line 428. For example, an equation similar to Equation 2 may be continuously used to weight pixel values for a red color for each pixel of first scan line 428. Pixel values for a red color for pixels R_{L2(13)}, R_{L2(14)}, etc. may be similarly weighted. Further, pixel values for a red color for pixels R_{L2(11)}, R_{L2(10)}, etc. may be similarly weighted.

Although not shown in FIG. 4, the reference color may be green, the second of the two alternate colors may be blue, and pixel values for the blue color of the second scan line 430 may be weighted by an interpolation using a red, green, and blue (RGB) color map. For example, using an equation similar to Equation 2, bilinear interpolation may be performed to weight pixel values for the blue color of the second scan line 430. Weighted bilinear interpolation may be performed to weight pixel values for a blue color of each pixel of second scan line 430.

Pixels adjacent to an edge of the image may be determined by an edge map. As used herein, an edge map may determine whether pixels are on an edge of an image and whether to use the pixels based on whether they are on an image edge. Pixels on an edge of an image may not be considered for use in interpolation, as they may include incorrect or incomplete color information. For example, pixels that may be on an edge of the image may not be used for bilinear interpolation, since incorrect or incomplete color information would be interpolated throughout the image.

The edge map may determine a plurality of pixels adjacent to a pixel on an edge of an image. For example, once a pixel is determined to be on an edge of an image, a plurality of pixels adjacent to the edge pixel may be determined using the edge map.

A pixel value for the first or the second of the two alternate colors for a pixel on an edge of an image may be interpolated using the plurality of adjacent pixels. For example, a pixel value for a red color for a pixel on an edge of an image may be interpolated using a plurality of pixels that are adjacent to the edge pixel.

The plurality of scan lines 426 may be filtered by a median filter. As used herein, a median filter may refer to a non-linear digital filtering technique to remove noise from an image. For example, after interpolating and weighting pixel values for the two alternate colors for first scan line 428, second scan line 430, and scan lines comprising the rest of the image, a median filter may be applied to the plurality of scan lines 426.

A quality of the plurality of scan lines 426 may be adjusted by a Gaussian filter. As used herein, a Gaussian filter may refer to a filter whose impulse response in a Gaussian function or Gaussian approximation. For example, after interpolating and weighting pixel values for the two alternate colors for first scan line 428, second scan line 430, and scan lines comprising the rest of the image, a Gaussian filter may be applied to improve the quality of the plurality of scan lines 426.

Although described as filtering the plurality of scan lines 426 by a median filter or a Gaussian filter, examples of the disclosure are not so limited. For example, filtering and/or improving the quality of the plurality of scan lines 426 may be performed by both a median filter and a Gaussian filter. As another example, any other suitable signal processing filter may be utilized to filter and/or improve the quality of the plurality of scan lines 426.

Information relating to an image including pixel values for the first of two alternate colors, the second of two alternate colors, and the reference color for the plurality of scan lines 426 may be displayed. For example, after interpolating and weighting pixel values for the red, blue, and green colors comprising the plurality of scan lines 426, a final scanned image that includes the plurality of scan lines 426 may be displayed on a display.

Information relating to the final image may be displayed on a user interface. As used herein, a user interface may include a graphical user interface (GUI) that may include a display, such as a screen, that may provide and/or receive information such as interpolated pixel values to and/or from a user. The display may be, for instance, a touch-screen (e.g., the GUI may include touch-screen capabilities). In some examples, a display may include a television, computer monitor, mobile device screen, or other type of display device. Examples of the disclosure, however, are not limited to a particular type(s) of user interface.

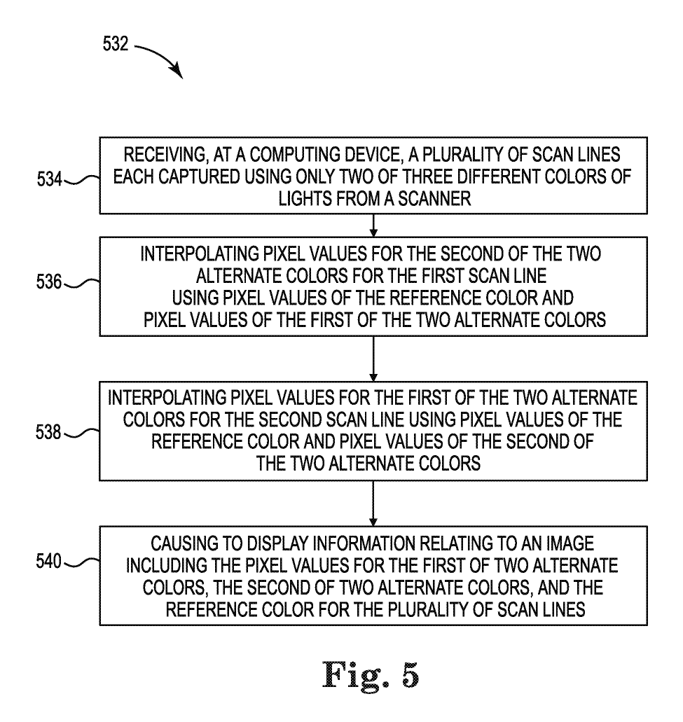

FIG. 5 illustrates a flow diagram depicting an example method 532 for interpolating pixel values consistent with the present disclosure. At 534, the method 532 may include receiving, at a computing device, a plurality of scan lines each captured using only two of three different colors of lights from a scanner. For instance, capturing the plurality of scan lines may include, illuminating a first scan line with a reference color and with a first of two alternate colors of the three different colors, and illuminating a second scan line with the reference color and with a second of the two alternate colors of the three different colors, as discussed herein.

At 536, the method 532 may include interpolating pixel values for the second of the two alternate colors for the first scan line by bilinear interpolation using pixel values of the reference color and pixel values of the first of the two alternate colors as discussed in relation to FIGS. 3 and 4. Similarly, at 538, the method 532 may include interpolating pixel values for the first of the two alternate colors for the second scan line by bilinear interpolation using pixel values of the reference color and pixel values of the second of the two alternate colors as discussed in relation to FIGS. 3 and 4.

At 540, the method 532 may include causing to display information relating to an image including the pixel values for the first of two alternate colors, the second of two alternate colors, and the reference color for the plurality of scan lines.

As described herein, interpolating pixel values may include receiving, from a scanner, a plurality of scan lines each captured using a green color and a red or a blue color of lights from the scanner. Pixel values for the blue color of a first scan line may be interpolated by bilinear interpolation using the green color and the red color. Pixel values for the red color of a second scan line may be interpolated by bilinear interpolation using the green color and the blue color. Information related to an image including the plurality of scan lines may be displayed via a user interface. Interpolating pixel values consistent with the present disclosure may allow for higher speed digital scanning of physical objects as compared to scanning using three exposures (e.g., red, green, and blue color exposures) per scan line, which may result in faster physical document per minute scan throughput.

The above specification, examples and data provide a description of the method and applications, and use of the system and method of the present disclosure. Since many examples may be made without departing from the spirit and scope of the system and method of the present disclosure, this specification merely sets forth some of the many possible example configurations and implementations.

What is claimed is:

1. A system, comprising:
a receiver engine to receive a plurality of scan lines each captured using only two of three different colors of lights from a scanner, wherein each scan line comprises received pixel values for the two different colors of lights used to illuminate the plurality of scan lines;
an interpolate engine to interpolate, using the received pixel values for the two different colors, pixel values for the third one of the three different colors for each scan line to result in a color map; and
a display engine to cause to display information relating to an image including the received pixel values and the interpolated pixel values for the three different colors for the plurality of scan lines.

2. The system of claim 1, wherein the interpolate engine determines the pixel values for the third color by weighted interpolation of the pixel values of the two colors with respect to the pixel values of the third color.

3. The system of claim 1, wherein the interpolated pixel values are weighted by the color map.

4. The system of claim 1, further including an edge map engine to determine pixels adjacent to a pixel on an edge of the image.

5. The system of claim 1, wherein the interpolate engine uses red and green colors for the pixel values of each scan line to interpolate pixel values for a blue color for each scan line.

6. The system of claim 1, wherein the interpolate engine uses green, and blue colors for the pixel values of each scan line to interpolate pixel values for a red color for each scan line.

7. A method, comprising:
receiving, at a computing device, a plurality of scan lines each captured using only two of three different colors of lights from a scanner, wherein capturing the plurality of scan lines includes:
illuminating a first scan line with a reference color and with a first of two alternate colors of the three different colors; and
illuminating a second scan line with the reference color and with a second of the two alternate colors of the three different colors;
interpolating pixel values for the second of the two alternate colors for the first scan line using pixel values of the reference color and pixel values of the first of the two alternate colors;
interpolating pixel values for the first of the two alternate colors for the second scan line using pixel values of the reference color and pixel values of the second of the two alternate colors; and
causing to display information relating to an image including the pixel values for the first of two alternate colors, the second of two alternate colors, and the reference color for the plurality of scan lines.

8. The method of claim 7, wherein the reference color is green, the first of the two alternate colors is red, and wherein the pixel values for the red color for the first scan line are weighted by an interpolation using a red, green, blue (RGB) color map.

9. The method of claim 7, wherein the reference color is green, the second of the two alternate colors is blue, and wherein the pixel values for the blue color for the second scan line are weighted by an interpolation using a red, green, blue (RGB) color map.

10. The method of claim 7, wherein the method includes determining a plurality of pixels adjacent to a pixel on an edge of the image by an edge map.

11. The method of claim 10, wherein the method includes interpolating the pixel value for the first or the second of the two alternate colors for the pixel on the edge of the image using the plurality of adjacent pixels.

12. A non-transitory computer readable medium storing instructions executable by a processing resource to cause a computing device to:
receive, from a scanner, a plurality of scan lines each captured using a green color and a red or a blue color of lights from the scanner;
interpolate, using the green color and the red color, pixel values for the blue color of a first scan line;
interpolate, using the green color and the blue color, pixel values for the red color of a second scan line; and
cause to display, via a user interface, information related to an image including the plurality of scan lines.

13. The medium of claim 12, comprising instructions to interpolate the pixel values for the blue color of the first scan line and the pixel values for the red color of the second scan line by bilinear interpolation.

14. The medium of claim 12, comprising instructions to interpolate the pixel values for the blue color of the first scan line and the pixel values for the red color of the second scan line by bicubic interpolation.

15. The medium of claim 12, comprising instructions to interpolate the pixel values for the blue color of the first scan line and the pixel values for the red color of the second scan line by spline based interpolation.
